(19) United States
(12) Patent Application Publication
(10) Pub. No.: US 2009/0017745 A1
(43) Pub. Date: Jan. 15, 2009

(54) Ventilation apparatus for fuel cell vehicle

(75) Inventors: Young Bum Kum, Seoul (KR); Sae Hoon Kim, Gyeonggi-do (KR); Sung Ho Lee, Gyeonggi-do (KR); Kwi Seong Jeong, Gyeonggi-do (KR); Duck Whan Kim, Seoul (KR); Hyuck Roul Kwon, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/218,123

(22) Filed: Jul. 11, 2008

(30) Foreign Application Priority Data
Jul. 13, 2007 (KR) 10-2007-0070582

(51) Int. Cl. B60H 1/24

(52) U.S. Cl. 454/156

(57) ABSTRACT

The present invention provides a ventilation apparatus for a fuel cell vehicle, which can rapidly remove high-temperature air generated in the inside of a stack case by moving the same to an air cleaner using a suction pressure of air supplied for the operation of the fuel cell vehicle, reduce the risk incurred due to hydrogen leakage by moving leaking hydrogen to the air cleaner, and maintain the temperature of a fuel cell stack constant.

### CROSS-REFERENCE TO RELATED APPLICATION

This application claims under 35 U.S.C. §119(a) the benefit of Korean Patent Application No. 10-2007-0070582 filed Jul. 13, 2007, the entire contents of which are incorporated herein by reference.

### BACKGROUND

(a) Technical Field

The present invention relates to a ventilation apparatus for a fuel cell vehicle. More particularly, the present invention relates to a ventilation apparatus for a fuel cell vehicle, which can rapidly remove high-temperature air generated in the inside of a stack case by moving the same to an air cleaner using a suction pressure of air supplied for the operation of the fuel cell vehicle, reduce the risk incurred due to hydrogen leakage by moving leaking hydrogen to the air cleaner, and maintain the temperature of a fuel cell stack constant.

(b) Background Art

In general, a fuel cell stack is a power generation device that is mounted in a hybrid electric vehicle to generate electrical power required to drive a motor, in which hydrogen, air and coolant should be continuously circulated for the operation thereof, and the electrical power generated in the fuel cell stack should be safely used.

Since the fuel cell stack is mounted in the vehicle, it is necessary to ensure a stable and steady state to improve the mountability into the vehicle. Moreover, the generated electrical power should not incur a risk to the vehicle and, since the hydrogen is circulated, it is necessary to prevent explosion due to hydrogen leakage.

Furthermore, in order to prevent contamination from the outside, a stack case for accommodating the fuel cell stack and maintaining an airtightness is provided on the outside of the fuel cell stack. The stack case prevents contamination by dust and moisture from the outside and also prevents problems due to condensed water generated by a change in temperature of the fuel cell stack and due to the hydrogen leakage.

To provide ventilation of the stack case, conventionally, a pump is provided on the outside of the stack case so that outside air is introduced and passed through the inside of the stack case, thus removing the condensed water generated by the temperature change in the fuel cell stack. Moreover, a moisture absorbent is provided in the inside of the stack case to remove moisture.

In addition, a filter is provided in the front portion of the stack case, and a fan is disposed in the rear portion thereof such that the outside air flows in the inside of the stack case by a driving force of the fan.

The conventional ventilation apparatuses have drawbacks in that they need additional power to drive the pump and the fan, which may increase the overall weight of the vehicle and manufacturing cost and decrease fuel efficiency.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. In one aspect, the present invention provides a ventilation apparatus for a fuel cell vehicle, the ventilation apparatus comprising: a stack case for accommodating a fuel cell stack mounted in the fuel cell vehicle and generating electrical power; and an air cleaner provided on a portion of the top of the stack case for cleaning air drawn from the outside. In this case, a connection hole is provided at a position where a portion of a bottom cover of the air cleaner is in contact with a portion of the top of the stack case so as to make the air cleaner in communication with the stack case, through which connection hole air in the inside of the stack case can be moved to the air cleaner by a difference between a pressure of air introduced into the air cleaner and a pressure of the inside of the stack case.

In another aspect, the present invention provides a ventilation apparatus for a fuel cell vehicle, the ventilation apparatus comprising: a stack case for accommodating a fuel cell stack mounted in the fuel cell vehicle and generating electrical power; an air cleaner provided on a portion of the top of the stack case for cleaning air drawn from the outside; and an air hose connected between the air cleaner and an air blower for supplying air to the fuel cell stack. Here, the air hose comprises a first ventilation hose, of which one end is connected to the air hose and the other end is connected to the stack case such that air in the inside of the stack case can be moved to the air hose by a difference between a pressure of air introduced through the air hose and a pressure of the inside of the stack case.

In a further aspect, the present invention provides a ventilation apparatus for a fuel cell vehicle, the ventilation apparatus comprising: a stack case for accommodating a fuel cell stack mounted in the fuel cell vehicle and generating electrical power; an air discharge pipe connected to one side of the stack case for discharging air from the fuel cell stack; and a second ventilation hose, of which one end is connected to the air discharge pipe and the other end is connected to the stack case such that air in the inside of the stack case can be moved to the air discharge pipe by a difference between a pressure of air moved through the air discharge pipe and a pressure of the inside of the stack case.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a diagram showing a ventilation apparatus for a fuel cell vehicle in accordance with a first preferred embodiment of the present invention;

FIG. 2 is a cross-sectional view showing an assembled state of the ventilation apparatus for a fuel cell vehicle of FIG. 1;

FIG. 3 is a diagram showing a discharge port and an air cleaner port included in the ventilation apparatus for a fuel cell of FIG. 1;

FIG. 4 is a diagram showing an air cleaner provided in the ventilation apparatus for a fuel cell vehicle of FIG. 1;

FIG. 5 is a diagram showing a hydrogen sensor provided in the ventilation apparatus for a fuel cell vehicle of FIG. 1;

FIG. 6 is a diagram showing a ventilation apparatus for a fuel cell vehicle in accordance with a second preferred embodiment of the present invention; and

FIG. 7 is a diagram briefly showing a ventilation apparatus for a fuel cell vehicle in accordance with a third preferred embodiment of the present invention.

Reference numerals set forth in the Drawings includes reference to the following elements as further discussed below:

| | |
|---|---|
| 2: fuel cell stack | 100: stack case |
| 200: air cleaner | 210: air duct |
| 300: connection hole | 400: air hose |
| 500: first ventilation hose | 600: air discharge pipe |
| 700: second ventilation hose | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

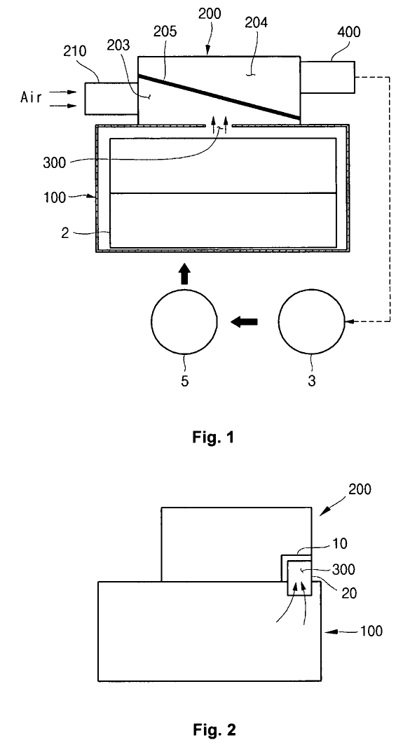

Referring to FIGS. 1 to 5, a ventilation apparatus for a fuel cell vehicle in accordance with a first preferred embodiment of the present invention will be described in detail.

The ventilation apparatus includes a stack case 100 for accommodating a fuel cell stack 2 (hereinafter referred to as a stack) mounted in the fuel cell vehicle and generating electrical power, and an air cleaner 200 provided on a portion of the top of the stack case 100 and cleaning air drawn from the outside. A connection hole 300 is provided at a position where a portion of the bottom of a lower cover of the air cleaner 200 is contact with a portion of the top of the stack case 100 such as to make the stack case 100 in communication with the air cleaner 200. Through the connection hole 300, air in the inside of the stack case 100 is moved to the air cleaner 200 by a difference between the pressure of air introduced into the air cleaner 200 and the pressure of the inside of the stack case 100.

It is preferable that the inside top of the stack case 100 and the top of the stack 2 are spaced apart from each other to facilitate the air flow therebetween. In particular, the stack 2 generates heat by an electrochemical reaction between hydrogen and oxygen during operation and the generated heat increases the temperature of air. The thus generated high-temperature air is moved to the space between the inside top of the stack case 100 and the top of the stack 2.

The air cleaner 200 includes a filter 10 provided on the connection hole 300 to prevent dust and moisture from being introduced into the inside of the stack case 100 during introduction of the outside air.

The connection hole 300 of the air cleaner 200 may have a diameter smaller than that of the air cleanser 200. Preferably, a tubular insertion pipe 20 may be separately disposed between the air cleaner 200 and the stack case 100. The filter 10 may be disposed on one end of the top of the insertion pipe 20 to prevent dust and moisture from being introduced into the inside of the stack case 100.

An air duct 210 through which the outside air is introduced is provided on the air cleaner 200. Moreover, an air cleaner port 202, of which one end is connected to a portion of the lateral surface of the air duct 210 and the other end extends to a portion of the outside of the air duct 210, may be provided on the air cleaner 200 so as to prevent dust and moisture contained in the air from being introduced into the inside of the stack case 100.

The air cleaner port 202 of the air cleaner 200 may be inclined in the range of 90° or less with respect to the bottom surface of the air duct 210 (see θ of FIG. 4).

A discharge port 110 may be provided on a portion of the outside of the stack case 100. The discharge port 110 is connected to the air cleaner port 202 so as to discharge moisture in the air introduced through the air cleaner 200.

A hydrogen sensor 4 may be provided in the vicinity of the discharge port 110 on the stack case 100 to detect hydrogen leakage from the stack 2.

The inside of the air cleaner 200 is divided into a dirty area 203 corresponding to a lower portion and a clean area 204 corresponding to an upper portion with respect to an air cleaner filter 205 provided therein. The dirty area 203 is connected to the connection hole 300 disposed between the air cleaner 200 and the stack case 100.

Referring to FIG. 6, the ventilation apparatus for a fuel cell vehicle in accordance with a second preferred embodiment of the present invention will be described.

The ventilation apparatus includes a stack case 100 for accommodating a stack 2 mounted in the fuel cell vehicle and generating electrical power, an air cleaner 200 provided on a portion of the top of the stack case 100 and cleaning air drawn from the outside, and an air hose 400 connected between the air cleaner 200 and an air blower 3 (shown in FIG. 1) for supplying air to the stack 2. At least one first ventilation hose 500 is provided. One end of the first ventilation hose 500 is connected to the air hose 400 and the other end thereof is connected to a portion of the stack case 100 such that air in the inside of the stack case 100 can be moved to the air hose 400 by a difference between the pressure of air introduced through the air hose 400 and the pressure of the inside of the stack case 100.

As shown in FIG. 6, a filter 10′ may be provided inside the stack case 100 to remove contaminants contained in the air in the stack case 100 before being moved through the air hose 400.

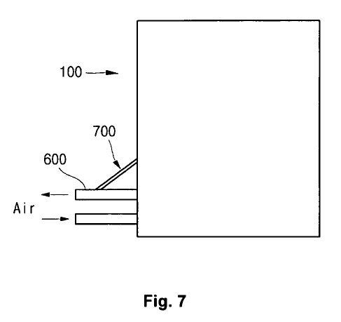

Referring to FIG. 7, a ventilation apparatus for a fuel cell vehicle in accordance with a third preferred embodiment of the present invention will be described.

The ventilation apparatus includes a stack case 100 for accommodating a stack 2 mounted in the fuel cell vehicle and generating electrical power, an air discharge pipe 600 connected to a portion of one side of the stack case 100 for discharging air from the stack 2, and a second ventilation hose 700, of which one end is connected to a portion of the air discharge pipe 600 and the other end is connected to a portion of the stack case 100 such that air in the inside of the stack case 100 can be moved to the air discharge pipe 600 by a difference between the pressure of air moved through the air discharge pipe 600 and the pressure of the inside of the stack case 100.

Hereinafter, operation modes of the above-described ventilation apparatuses will be described.

Operation mode of the ventilation apparatus for a fuel cell vehicle in accordance with the first preferred embodiment of the present invention will be described with reference to FIGS. 1 to 5.

When the fuel cell vehicle is turned on, outside air is introduced through the air duct 210 of the air cleaner 200 by the operation of the air blower 3. While the outside air passes through the air duct 210, the dirty area 203, and the air cleaner filter 205, contaminants contained in the outside air are filtered, and the thus purified air is supplied to the clean area 204.

At this time, there occurs a difference between the pressure of air introduced into the air cleaner 200 and the pressure of the inside of the stack case 100. The pressure difference according to the operation of the air blower 3 is varied according to revolutions per minute (RPM) of the air blower 3, and a negative pressure is generated in the dirty area 203 of the air cleaner 200.

As above, the air in the inside of the stack case 100 is moved to the dirty area 203 through the connection hole 300 as shown by arrows in FIG. 1 by the difference in pressure between the air cleaner 200 and the stack case 100, and then supplied to the stack 2 by way of the air cleaner filter 205 and the clean area 204 by the operation of the air blower 3.

Referring to FIG. 2, the filter 10 disposed on the top of the insertion pipe 20 prevents moisture from being introduced into the stack 2 through the air cleaner 200 during the stop of the fuel cell vehicle or in case of rain.

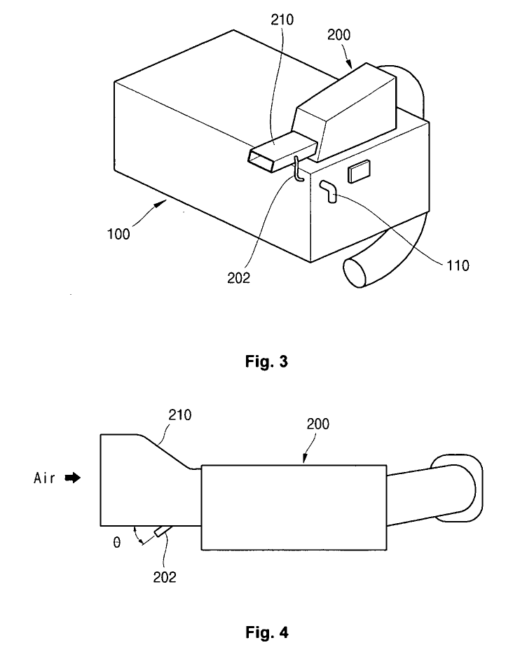

Referring to FIGS. 3 and 4, the outside air introduced through the air duct 210 of the air cleaner 200 may contain dust and moisture. The dust and moisture are moved through the air cleaner port 202 and discharged to the outside of the air cleaner 200. The air cleaner port 202 may be variously inclined with an angle value of θ. The angle value of θ may be in the range of 90° or less.

The air cleaner port 202 is connected to the discharge port 110 provided on the stack case 100 so as to discharge dust and moisture introduced through the air duct 210 to the outside of the stack case 100.

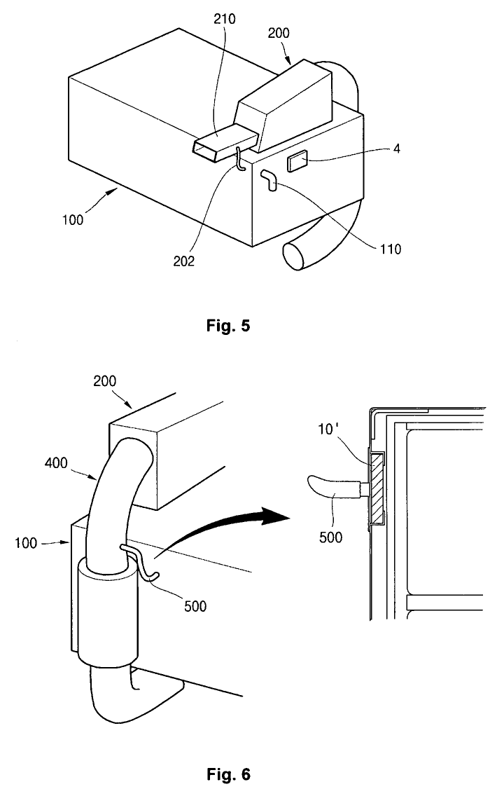

Referring to FIG. 5, hydrogen gas may leak from the stack 2 accommodated in the stack case 100 due to a broken separator (not shown) or an aging gasket (not shown). Like this, in the event that the hydrogen gas leaks, the hydrogen sensor 4 provided in the vicinity of the discharge port 110 detects the hydrogen leakage and transmits a detection signal to a controller (not shown). Then, the controller operates a warning light (not shown) to provide a warning signal to a driver or controls the fuel cell vehicle to be stopped.

Next, operation mode of the ventilation apparatus for a fuel cell vehicle in accordance with the second preferred embodiment of the present invention will be described with reference to FIG. 6.

When the outside air moved through the air cleaner 200 and the air hose 400 passes through the area where the first ventilation hose 500 is provided, a negative pressure is generated around the first ventilation hose 500. As a result, the high-temperature air generated in the inside of the stack case 100 is introduced into the air hose 400 through the first ventilation hose 500 and then filtered by the filter 10′ provided to remove contaminants which may remain in the inside of the stack case 100 such that the thus purified air is moved to the air hose 400. Like this, the air moved to the air hose 400 is humidified by a humidifier 5 by the operation of the air blower 3 and then supplied to the stack 2. The higher the speed of the vehicle is, the more the amount of air introduced from the stack case 100 into the air hose 400 through the first ventilation hose 500 is. The air introduced from the stack case 100 is of high temperature. As above, the high-temperature air introduced into the air hose 400 is humidified by the humidifier 5 and recirculated to the stack. Moreover, the air hose 400 is connected to the clean area of the air cleaner 200. A plurality of first ventilation hoses 500 may be provided according to engine displacement and the number thereof is not particularly limited.

Lastly, operation mode of the ventilation apparatus for a fuel cell vehicle in accordance with the third preferred embodiment of the present invention will be described with reference to FIG. 7.

The stack case 100 may be provided in various positions according to the layout of the vehicle. In general, the stack case 100 may be provided on an engine room (not shown); however, in the case where it is provided on the bottom of the vehicle, the second ventilation hose 700 may be disposed between the air discharge pipe 600 and the stack case 100 in a state that the air cleaner 200 is positioned on the engine room.

In this case, the diameter of the second ventilation hose 700 is smaller than that of the air discharge pipe 600 such that the high-temperature air in the inside of the stack case 100 can be discharged to the outside by a difference between the pressure of air discharged through the air discharge pipe 600 and the pressure of the inside of the stack case 100 as shown by arrows in the figure.

Accordingly, it is possible to prevent the stack 2 from being damaged or malfunctioning which may be caused by the high-temperature heat generated in the stack 2. Moreover, the high-temperature air generated in the stack 2 is continuously recirculated or discharged to the outside of the stack case 100, thus ensuring a stable running of the travel.

As described above, the ventilation apparatuses for a fuel cell vehicle in accordance with the present invention provides various effects including the following.

The high-temperature air generated in the fuel cell stack is reused or stably recirculated to maintain the temperature of the fuel cell stack constant, thus providing a stable power generation and ensuring safety of the vehicle against the leakage of hydrogen gas.

Moreover, it is possible to prevent contaminants contained in the outside air from being supplied to the stack, thus increasing the durability of the fuel cell stack, and minimizing the damage of the separator and gasket provided in the fuel cell stack. As a result, the durability of the fuel cell vehicle is increased.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A ventilation apparatus for a fuel cell vehicle, the ventilation apparatus comprising:
a stack case for accommodating a fuel cell stack mounted in the fuel cell vehicle and generating electrical power; and
an air cleaner provided on a portion of the top of the stack case for cleaning air drawn from the outside,
wherein a connection hole is provided at a position where a portion of a bottom cover of the air cleaner is in contact with a portion of the top of the stack case so as to make the air cleaner in communication with the stack case, through which connection hole air in the inside of the stack case can be moved to the air cleaner by a difference between a pressure of air introduced into the air cleaner and a pressure of the inside of the stack case.

2. The ventilation apparatus of claim 1, wherein the air cleaner comprises a filter provided on the connection hole to prevent dust or moisture from being introduced into the inside of the stack case during introduction of the outside air.

3. The ventilation apparatus of claim 1, wherein the connection hole has a diameter smaller than that of the air cleaner.

4. The ventilation apparatus of claim 1, wherein the air cleaner comprises an air duct for introducing the outside air and an air cleaner port for preventing dust and moisture contained in the introduced air from being introduced into the inside of the stack case, one end of the air cleaner port being connected to a portion of the lateral surface of the air duct and the other end being connected to a portion of the outside of the air duct.

5. The ventilation apparatus of claim 4, wherein the air cleaner port is inclined in the range of 90° or less with respect to the bottom surface of the air duct.

6. The ventilation apparatus of claim 4, wherein the stack case comprises a discharge port provided on the outside of thereof to discharge moisture in the outside air introduced through the air cleaner, the discharge port being connected to the air cleaner port.

7. The ventilation apparatus of claim 6, wherein the stack case comprises a hydrogen sensor provided in the vicinity of the discharge port on the stack case to detect hydrogen leakage from the fuel cell stack.

8. The ventilation apparatus of claim 1, wherein the air cleaner includes an air cleaner filter provided therein, a portion below the air cleaner filter being a dirty area and a portion above the air cleaner filter being a clean area, and the dirty area being connected to the connection hole disposed between the air cleaner and the stack case.

9. A ventilation apparatus for a fuel cell vehicle, the ventilation apparatus comprising:
a stack case for accommodating a fuel cell stack mounted in the fuel cell vehicle and generating electrical power;
an air cleaner provided on a portion of the top of the stack case for cleaning air drawn from the outside; and
an air hose connected between the air cleaner and an air blower for supplying air to the fuel cell stack,
wherein the air hose comprises a first ventilation hose, of which one end is connected to the air hose and the other end is connected to the stack case such that air in the inside of the stack case can be moved to the air hose by a difference between a pressure of air introduced through the air hose and a pressure of the inside of the stack case.

10. The ventilation apparatus of claim 9, wherein the air hose comprises a plurality of the first ventilation hose.

11. The ventilation apparatus of claim 9, wherein the stack case is provided with a filter therein for removing contaminants contained in the air in the stack case before being moved through the air hose.

12. A ventilation apparatus for a fuel cell vehicle, the ventilation apparatus comprising:
a stack case for accommodating a fuel cell stack mounted in the fuel cell vehicle and generating electrical power;
an air discharge pipe connected to one side of the stack case for discharging air from the fuel cell stack; and
a second ventilation hose, of which one end is connected to the air discharge pipe and the other end is connected to the stack case such that air in the inside of the stack case can be moved to the air discharge pipe by a difference between a pressure of air moved through the air discharge pipe and a pressure of the inside of the stack case.
